(19) United States
(12) Patent Application Publication
(10) Pub. No.: US 2008/0054765 A1
(43) Pub. Date: Mar. 6, 2008

(54) Encoder

(75) Inventors: Joseph Siraky, Donaueschingen (DE); Rolf Hartlieb, Villingen-Schwenningen (DE)

Correspondence Address: THE NATH LAW GROUP, 112 South West Street, Alexandria, VA, 22314, US

(73) Assignee: SICK STEGMANN GmbH, Donaueschingen (DE)

(21) Appl. No.: 11/882,796

(22) Filed: Aug. 6, 2007

(30) Foreign Application Priority Data
Sep. 4, 2006 (EP) 06 018 418.1

(51) Int. Cl. G01B 21/22

(52) U.S. Cl. 310/68 B

(57) ABSTRACT

An encoder for recording measured values, which depend on the rotating angle between a shaft (12) and a housing (10) containing the shaft (12), exhibits a stator (20) which is secured to the housing (10), a rotor (30) which is secured to the shaft (12), and a scanner which records the rotation of the rotor (30) relative to the stator (20). An elastic ring (42) with supporting points (44) rests on the circumference of the stator (20). In the mounting process the encoder is positioned on the shaft until the stator (20) is axially braced against the housing with the supporting points (44) of the elastic ring (42). In this auxiliary position the rotor (30) is fixed in position on the shaft. Then the stator is pressed against the housing while working against the force of the elastic ring (42) and is secured to the housing.

The invention relates to an encoder for recording measured values, which depend on the angle of rotation between a shaft and a housing that contains the shaft, in accordance with the preamble of claim 1.

Encoders of this type are used for the incremental or absolute measurement of the angle of rotation, angular speed, angular acceleration, and the like, of objects that rotate relative to each other. The most frequent application is the measurement of the rotating motion of a shaft in a housing that contains the shaft, e.g., the measurement of the motor shaft of an electromotor. The encoder exhibits a rotor and a stator. The stator is mounted to the housing in torque-proof fashion. A scanner records the rotation of the rotor relative to the stator, and this requires that the rotor revolves, both axially and radially, with sufficient precision relative to the stator, which as a rule supports the scanner.

The prior art is acquainted with encoders which, to achieve these ends, call for the rotor to be mounted in the stator with a roller bearing. The precise rotation of the rotor relative to the stator is thereby guaranteed. To be sure, it is generally necessary for the stator to be secured elastically to the housing, or the rotor to the shaft, to equalize axial and radial tolerances in the mounting of the shaft relative to the housing. A constructive expense is associated with the mounting of the rotor in the stator and the elastic mounting of the rotor, or stator, to the measured objects.

Also known are encoders of the initially mentioned type that are made cost-effective in that the rotor is not mounted with a mechanical roller bearing. The stator is fixed directly to the housing, while the rotor rests directly on the shaft. Any running errors of the shaft relative to the housing result in corresponding running errors of the rotor in the stator, so that the rotor must rotate with a certain axial tolerance relative to the stator. In a typical example, the rotor is designed as a rotating disk, which rotates at an axial distance of several tenths of a millimeter from a fixed disk belonging to the stator; here the disk belonging to the rotor supports a material measure that is incrementally or absolutely coded and which is scanned by a scanner positioned on the disk of the stator. The material measure and the scanner can have an optical, magnetic, or electro-inductive design.

Since the rotor is not mechanically mounted in the stator, the rotor must be positioned in the stator during assembly of the encoder. Here it is known to use mounting means to first bring the stator into an initial auxiliary position—one in which the stator has a defined axial spacing vis-à-vis the placement site of the housing. More specifically, this axial distance will correspond to the intended axial spacing between the stator and rotor in the final, mounted state. The mounting means consist of a tool in the form of a flat fork, which is inserted between the placement site of the housing and the stator and which establishes the distance between these parts. The rotor is then positioned axially on the shaft so that it rests axially against the assigned stator area. In this position the rotor is fixed on the shaft. Then the fork-shaped tool located between the stator and the housing is pulled out from the side. The stator is then moved completely over the pre-established axial spacing distance to come against the housing, where it is fixed in position. This provides the required axial spacing between the rotor and the stator, as intended for the contact-free rotation of the rotor with the needed axial tolerance.

In this known encoder the mounting process requires a further tool as a means for assembly. This tool is inserted radially from the outside, between the placement site of the housing and the stator of the encoder, and for spatial reasons this action is difficult in certain cases of encoder installation.

The invention is based on the goal of facilitating the mounting process for an encoder of the type initially described.

This goal is achieved with an encoder exhibiting the features of patent claim 1.

Advantageous embodiments of the invention are indicated in the secondary claims.

In accordance with the invention, the mounting means that are employed take the form of a spacer, which first holds the stator of the encoder in an initial auxiliary position at the predetermined axial distance from the housing. In this first auxiliary position the rotor on the shaft is brought to rest against the stator and is fixed in position on the shaft. Through deformation of the spacer the stator is then pressed against the housing and is fixed in position on the housing. Ideally the spacer will be attached to the encoder and will remain on the encoder after assembly. Consequently no additional tool is required for the mounting process and no free space to the side of the encoder for the insertion of such a tool.

Ideally the spacer will take the form of a spring element, which is elastically deformed.

In a simple embodiment the spring element takes the form of an elastic ring, which rests on the outer circumference of the stator and with its points of support protrudes axially over the side of the stator that faces the housing and uses these points of support to brace itself at the placement site of the housing. In this way the stator is kept in the auxiliary position, at the predetermined axial distance from the housing. After the rotor is positioned and attached, the stator need only be pressed against the housing and fixed in positioned on the housing. In the process, the supporting points of the elastic ring are pressed axially backwards, so that they are located behind the face of the stator, on the latter's outer circumference. The elastic ring will ideally consist of an economically produced plastic part.

In the following the invention is described in greater detail on the basis of exemplary embodiments shown in the drawing. Shown are:

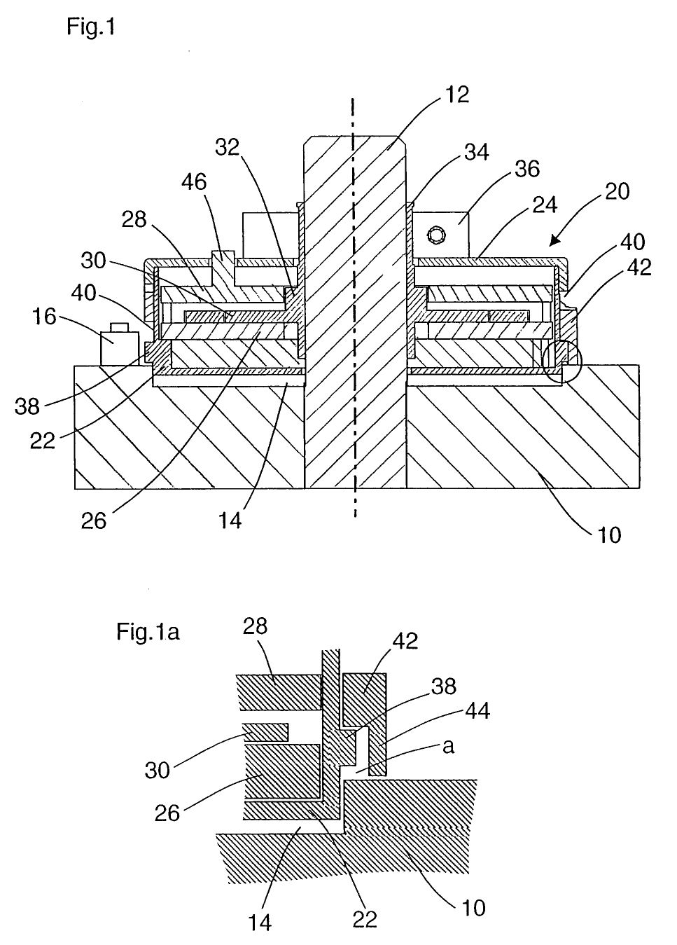

FIG. 1 an axial section through the encoder, depicted in the auxiliary position during assembly

FIG. 1a an enlarged section from FIG. 1

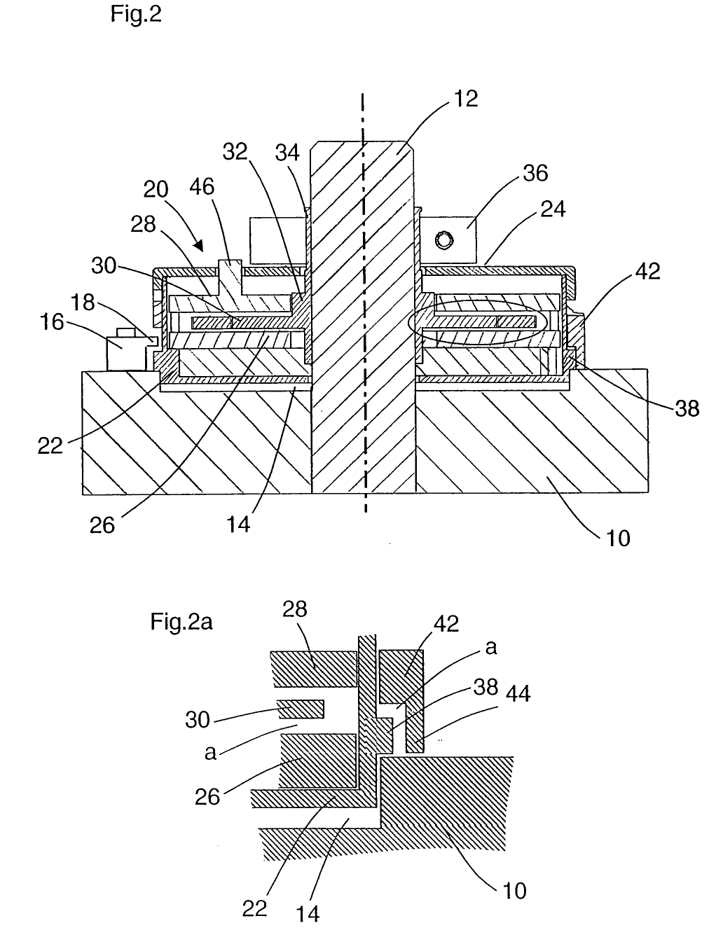

FIG. 2 an axial section corresponding to FIG. 1, showing the encoder in mounted position

FIG. 2a an enlarged section from FIG. 2

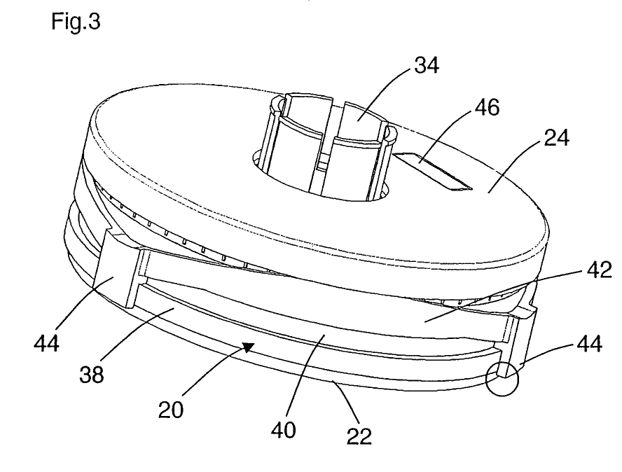

FIG. 3 a perspective view of the encoder.

The exemplary embodiment depicts the manner in which the encoder is mounted onto an electromotor for the purpose of recording the rotational movement of the motor shaft. Of the motor, a section of its housing 10 is depicted, as well as the shaft 12 protruding from the housing 10. Formed in the placement site of the housing 10 is a sunken recess or seat 14, in the shape of a circular disk designed to surround the shaft 12 concentrically. The encoder is inserted into this seat. External to the seat, and around it, are three brackets 16 positioned at angles of 120° relative to each other. Each of these brackets has a projection 18 that can be swiveled inward and over the seat 14.

The encoder exhibits a stator 20, which is slid coaxially onto the shaft 12, such that the shaft 12 passes through the stator 20 in freely rotating fashion. The stator 20 has a cylindrical housing, with a lower part 22 and a lid 24. Positioned in the lower part 22 is a lower guide plate 26, which essentially covers the base of the lower part 22; there is also an upper guide plate 28, which is axially spaced above this lower guide plate 26. The guide plates 26 and 28 are firmly attached to the lower part 22 of the stator 20.

The encoder also exhibits a rotor 30, which takes the form of a disk and is concentrically mounted on a bushing 32. The disk of the rotor 30 is located axially between the lower guide plate 26 and the upper guide plate 28 and runs on a plane parallel to them. The bushing 32 with the rotor 30 is able to freely rotate within the stator. In the outward direction, the bushing 32 projects axially over the lid 24 of the stator, and the end of the bushing 32 which projects over the lid 24 is axially slotted in the form of a collet 34. Seated on this end projecting over the lid and designed as a collet 34 is a tension ring 36. The inner diameter of the bushing 32 matches the diameter of the shaft 23, and the rotor 30, along with the busing 32, can be slid onto the shaft 12 axially and fixed in position on the shaft 12 by mounting the tension ring 36 by means of the collet 34.

The lower part 22 of the stator 20 is shaped like a cylindrical pot. Its lower face has an outer diameter which matches the inner diameter of the seat 14, so that the lower part 22 can be inserted into said seat 14 and centered on the shaft 12. At an axial distance from the lower floor area of the lower part 22, the outer circumference of the lower part 22 widens in the shape of a collar 38, with an outer diameter which is greater than the inner diameter of the seat 14. Above the collar 38 the outer diameter of the lower part 22 again grows smaller. The lid 24, which is mounted on the lower part 22 and is fixed in place, outwardly overlaps the upper rim of the lower part 22. As a result, a circumferential groove 40 is formed on the outer circumference of the lower part 22, between the lower edge of the lid 24 and the upper rim of the collar 38.

Inserted into this circumferential groove 40 is an elastic ring 42 made of plastic. The elastic ring 42 rests in the circumferential groove 40 as a closed, circular ring, and to this end the elastic ring 42 is slid onto the lower part 22 from above, before the lid is mounted. As is best seen in FIG. 3, the elastic ring 42 has an axial width that is smaller than the axial width of the circumferential groove 40. The elastic ring 42 runs circumferentially in the shape of a wave, so that it rests with its upper edge against the lower edge of the lid 24 at three points that are positioned at an angle of 120° relative to each other. At the central circumferential position between these points resting against the lid 24 the elastic ring 42 rests with its lower edge against the upper edge of the collar 38. At each of these lower positions resting against the collar 38, a supporting point 44 is formed on the elastic ring. In the form of an axially extending lobe, each of these supporting points 44 overlaps the collar 38 on its outer circumference and projects axially above the lower edge of the collar 38.

In a manner known to the prior art, the rotor 30 supports a material measure that is either incrementally or absolutely coded. The lower guide plate 26 and the upper guide plate 28 support a scanner for this material measure, as well as the appertaining electronic equipment. The connections for the electronic equipment are led to the outside by a connector 46 located on the top of the lid 24. The material measure and the scanner may be designed in a conventional manner, either optically, magnetically, or inductively.

In assembling the encoder the lower guide plate 26 is first inserted into the lower part 22 of the stator 20. Then the rotor 30 and its bushing 32 are inserted, and then the upper guide plate 28 is inserted into the lower part. During this process, the rotor 30 can move freely between the lower guide plate 26 and the upper guide plate 28 in the axial direction. Then the elastic ring 42 is slid from the outside onto the lower part 22, and finally the lid 24 is fixed into position on the lower part 22.

To mount the encoder onto the electromotor the encoder is slid onto the shaft 12. Here the bushing 32 of the rotor 30 slides along the shaft, while the stator 20 can move freely in the axial direction relative to the rotor 30. The encoder is pushed along the shaft toward the housing 10, until the base of the lower part 22 engages with the seat and the elastic ring 42, with its supporting points 44, comes to rest on the housing 10 outside the seat 14. This situation is depicted in FIG. 1 and 1a. Since the elastic ring 42 braces itself both on the housing 10 with its supporting points 44, and on the lid 24 with the points of its upper rim, the stator 20 holds the elastic ring 42 in an axially defined auxiliary position relative to the housing 10. Because the supporting points 44 project axially over the collar 38, in this auxiliary position a defined axial spacing distance ‘a’ is established between the housing 10 and the lower edge of the collar 38.

When the stator 20 is held in this auxiliary position by the elastic ring 42, which in this state is free of tension, the rotor 30, with its bushing 32 on the shaft 12, is pushed downwards until the rotor 30 rests axially on the surface of the lower guide plate 26, as is shown in FIGS. 1 and 1a. In this position the tension ring 36 is mounted, so that the rotor 30 is axially fixed on the shaft 12 in this position, and in a torque-proof manner.

Then the stator 20 is pressed down toward the housing 10 and against the elastic force of the elastic ring 42, until the collar 38 rests against the housing 10 with its lower nm, as shown in FIGS. 2 and 2a. The elastic ring 42 is elastically deformed in the process, and the supporting points 44 are pressed upwards until they reach a position behind the lower edge of the collar 38. In this mounting position, in which the stator 20 sits with its collar 38 on the housing 10, the stator 20 is secured to the housing by swiveling the projections 18 of the brackets 16 inwards so that they will axially overlap the collar. The brackets 16 are then mounted, so that the projections 18 press the stator 20 and its collar 38 against the housing 10.

This completes the assembly process. By pressing down the stator 20 over the axial distance ‘a’, the lower guide plate 26 is axially moved in the amount of that distance ‘a’ away from the rotor 30 secured to the shaft 12. The rotor 30 now lies at a defined axial distance from the lower guide plate 26 and the upper guide plate 28, so that said rotor 30 is able to rotate free of contact inside the stator 20. Here the axial distance from the lower guide plate 26 and the upper guide plate 28 is so chosen that tolerances for movement of the shaft 12 relative to the housing are acceptable. In general, the axial distance ‘a’ lies at an order of magnitude of several tenths of a millimeter, e.g., 0.4 mm.

### LIST OF REFERENCE NUMERALS

10 housing
12 shaft
14 seat
16 brackets
18 projection
20 stator
22 lower part
24 lid
26 lower guide plate
28 upper guide plate
30 rotor
32 bushing
34 collet
36 tension ring
38 collar
40 circumferential groove
42 elastic ring
44 supporting point
46 connector
a axial distance

1. Encoder for recording measured values, which depend on the rotating angle between a shaft (12) and a housing (10) which contains the shaft (12), with a stator (20) secured to the housing (10), with a rotor (30) secured to the shaft (12), with a scanner which records the rotation of the rotor (30) relative to the stator (20), and with mounting means which, in an initial auxiliary position, hold the stator (20) at a defined distance (a) from the housing (10), which distance (a) corresponds to the axial distance between the rotor (30) and the stator (20) that is required for contact-free rotation when the encoder is in assembled condition, and which mounting means make it possible to secure the stator (20) to the housing (10) in a second mounting position, wherein
the mounting means exhibit a spacer which holds the stator (20) in an auxiliary position, and the stator (20) can be moved into the mounting position and secured to the housing upon deformation of the spacer.

2. Encoder according to claim 1, wherein
the spacer is a spring element and the stator (20) can be moved against the elastic action of the spring element to occupy the mounting position.

3. Encoder according to claim 2, wherein
the spring element elastically braces the stator (20) against the housing 10).

4. Encoder according to claim 3, wherein
the spring element exhibits at least one spring (42), which is positioned on the stator (20) and braces itself against the housing (10).

5. Encoder according to claim 4, wherein
the spring is an elastic ring (42) which is concentrically positioned on the stator and which braces itself against the housing (10) on supporting points (44) distributed over the circumference.

6. Encoder according to claim 5, wherein
three supporting points (44) are provided, which are spaced at an angle of 120° relative to each other.

7. Encoder according to claim 5, wherein
the elastic ring (42) is mounted on the outer circumference of the stator (20), and protrudes axially, along with the supporting points (44), from the housing (10) over the face of the stator while in the relaxed condition of the auxiliary position, and is pressed axially behind the face of the stator (20), against the action of a spring force, in the mounted position.

8. Encoder according to claim 5, wherein
the elastic ring (42) is wave-shaped in the circumferential direction, is alternately braced against the stator (20), and is equipped with supporting points (44).

9. Encoder according to claim 5, wherein
the elastic ring is made of plastic.

10. Encoder according to claim 6, wherein
the elastic ring (42) is mounted on the outer circumference of the stator (20), and protrudes axially, along with the supporting points (44), from the housing (10) over the face of the stator while in the relaxed condition of the auxiliary position, and is pressed axially behind the face of the stator (20), against the action of a spring force, in the mounted position.

11. Encoder according to 6, wherein
the elastic ring (42) is wave-shaped in the circumferential direction, is alternately braced against the stator (20), and is equipped with supporting points (44).

12. Encoder according to claim 7, wherein
the elastic ring (42) is wave-shaped in the circumferential direction, is alternately braced against the stator (20), and is equipped with supporting points (44).

13. Encoder according to claim 6, wherein
the elastic ring is made of plastic.

14. Encoder according to claim 7, wherein
the elastic ring is made of plastic.

15. Encoder according to claim 8, wherein
the elastic ring is made of plastic.
